(19) United States
(12) Patent Application Publication
(10) Pub. No.: US 2017/0090163 A1
(43) Pub. Date: Mar. 30, 2017

(54) REAR CONVERTOR LENS AND IMAGING APPARATUS

(71) Applicant: FUJIFILM Corporation, Tokyo (JP)

(72) Inventor: Tetsuya ORI, Saitama-shi (JP)

(73) Assignee: FUJIFILM Corporation, Tokyo (JP)

(21) Appl. No.: 15/248,885

(22) Filed: Aug. 26, 2016

(30) Foreign Application Priority Data
Sep. 24, 2015 (JP) 2015-186957

(51) Int. Cl. G02B 13/02; G02B 9/30; G02B 9/24; G03B 17/14; G02B 27/00

(52) U.S. Cl. CPC G02B 13/02; G03B 17/14; G02B 27/0025; G02B 27/0018; G02B 9/24; G02B 9/30

(57) ABSTRACT

A rear converter lens consists of three lens groups of, in order from its object-side, a first lens-group having positive refractive power; a second lens-group having negative refractive power; and a third lens-group having positive refractive power. The first lens-group consists of a cemented lens of a negative lens having a concave surface facing an image-side of the rear converter lens and a positive lens cemented together in order from the object-side. The second lens-group consists of a cemented lens of a negative lens, a lens having a biconvex shape, and a negative lens cemented together in order from the object-side. The third lens-group includes a lens having a convex surface facing the object-side furthest toward the object-side. When the focal length of the third lens-group is f3 and the focal length of the rear converter lens is cf, conditional expression (1) (−1.9<f3/cf<−0.4) is satisfied.

### CROSS-REFERENCE TO RELATED APPLICATION

The present application claims priority under 35 U.S.C. §119 to Japanese Patent Application No. 2015-186957, filed on Sep. 24, 2015. The above application is hereby expressly incorporated by reference, in its entirety, into the present application.

### BACKGROUND

The present disclosure relates to a rear converter lens that increases the focal length of an entire system by being detachably attached to a rear side (an image side) of a master lens, and an imaging apparatus including the rear converter lens.

Conventionally, a rear converter lens (rear conversion lens) to be attached between a master lens (main lens) and a camera body was known, as an optical system that increases the focal length of the entire lens system by being detachably attached to the master lens. For example, Japanese Patent Publication No. H04(1992)-020165 (Patent Document 1), Japanese Patent Publication No. H04(1992)-020163 (Patent Document 2), Japanese Patent No. 4639581 (Patent Document 3) and Japanese Patent No. 4337352 (Patent Document 4) disclose optical systems in which rear converter lenses, each consisting of three groups of a first lens group having positive refractive power, a second lens group having negative refractive power and a third lens group having positive refractive power, are attached to master lenses.

### SUMMARY

In recent years, non-reflex digital cameras without optical finders have received attention, as imaging apparatuses. A rear converter lens to be attached to a non-reflex digital camera needs to achieve excellent optical performance of a combined optical system in which the rear converter lens is attached to a master lens. In addition, the rear converter lens needs to suppress an increase in the back focus of the combined optical system to prevent an increase in the total lens length of the combined optical system while maintaining the back focus of the combined optical system in a range in which the rear converter lens is attachable.

Here, in the rear converter lenses disclosed in Patent Documents 1 through 4, the back focus of a combined optical system in which a master lens and the rear converter lens are combined together is long, and that causes an increase in total lens length. Therefore, it is desirable that the back focus is further reduced.

In view of the foregoing circumstances, the present disclosure is directed to provide a rear converter lens having excellent optical performance, and which achieves appropriate back focus while suppressing an increase in total lens length, and an imaging apparatus including the rear converter lens.

A rear converter lens of the present disclosure is a rear converter lens having a negative focal length, and which makes the focal length of an entire system longer than the focal length of a master lens alone by being attached to an image side of the master lens. The rear converter lens consists of three lens groups of, in order from an object side of the rear converter lens, a first lens group having positive refractive power, a second lens group having negative refractive power and a third lens group having positive refractive power. The first lens group consists of a cemented lens of a negative lens having a concave surface facing an image side of the rear converter lens and a positive lens cemented together in order from the object side. The second lens group consists of a cemented lens of a negative lens, a positive lens having a biconvex shape, and a negative lens cemented together in order from the object side. The third lens group includes a lens having a convex surface facing the object side furthest toward the object side, and satisfies the following conditional expression (1):

−1.9<f3/cf<−0.4 (1), where
f3: the focal length of the third lens group, and
cf: the focal length of the rear converter lens.

In the rear converter lens of the present disclosure, it is desirable that one of the following conditional expressions (1-1), (2) and (2-1) is further satisfied, or it is desirable that any combination thereof is satisfied:

−1.7<f3/cf<−0.5 (1-1);

6.5<νd1−νd2<15 (2); and

7<νd1−νd2<13 (2-1), where

f3: the focal length of the third lens group,
cf: the focal length of the rear converter lens,
νd1: the Abbe number of the negative lens included in the first lens group for d-line, and
νd2: the Abbe number of the positive lens included in the first lens group for d-line.

In the rear converter lens of the present disclosure, it is desirable that the third lens group consists of a lens or a cemented lens.

An imaging apparatus of the present disclosure includes the rear converter lens of the present disclosure.

Here, the expression “consists of” and the expression “consisting of” mean that lenses substantially without any refractive power, optical elements other than lenses, such as a stop, masks and a glass cover, mechanical parts, such as a lens flange, a lens barrel, an imaging device and a hand shake blur correction mechanism, and the like may be included besides the mentioned composition elements. Further, the sign of the surface shape and the refractive power of the aforementioned lenses will be considered in a paraxial region in the case that an aspherical surface is included.

According to the present disclosure, it is possible to provide a rear converter lens having excellent optical performance, and which achieves appropriate back focus while suppressing an increase in total lens length, and an imaging apparatus including the rear converter lens.

### BRIEF DESCRIPTION OF THE DRAWINGS

FIG. 1 is a cross section of a lens corresponding to Example 1, which illustrates a first configuration example of a rear converter lens according to an embodiment of the present disclosure;

FIG. 2 is a cross section of a lens illustrating whole configuration in a state in which the first configuration example of the rear converter lens according to an embodiment of the present disclosure has been attached to a master lens;

FIG. 3 is a cross section of a lens illustrating whole configuration in a state in which the second configuration example of the rear converter lens according to an embodiment of the present disclosure has been attached to a master lens;

FIG. 4 is a cross section of a lens illustrating whole configuration in a state in which the third configuration example of the rear converter lens according to an embodiment of the present disclosure has been attached to a master lens;

FIG. 5 is a cross section of a lens illustrating whole configuration in a state in which the fourth configuration example of the rear converter lens according to an embodiment of the present disclosure has been attached to a master lens;

FIG. 6 is aberration diagrams illustrating various aberrations of a master lens alone, and illustrates a spherical aberration, astigmatism, distortion and a lateral chromatic aberration in order from the left side;

FIG. 7 is aberration diagrams illustrating various aberrations of a rear converter lens in Example 1 of the present disclosure (when the rear converter lens has been attached to a master lens), and illustrates a spherical aberration, astigmatism, distortion and a lateral chromatic aberration in order from the left side;

FIG. 8 is aberration diagrams illustrating various aberrations of a rear converter lens in Example 2 of the present disclosure (when the rear converter lens has been attached to a master lens), and illustrates a spherical aberration, astigmatism, distortion and a lateral chromatic aberration in order from the left side;

FIG. 9 is aberration diagrams illustrating various aberrations of a rear converter lens in Example 3 of the present disclosure (when the rear converter lens has been attached to a master lens) and illustrates a spherical aberration, astigmatism, distortion and a lateral chromatic aberration in order from the left side;

FIG. 10 is aberration diagrams illustrating various aberrations of a rear converter lens in Example 4 of the present disclosure (when the rear converter lens has been attached to a master lens), and illustrates a spherical aberration, astigmatism, distortion and a lateral chromatic aberration in order from the left side; and

FIG. 11 is a schematic diagram illustrating the configuration of an imaging apparatus including a rear converter lens according to an embodiment of the present disclosure.

### DETAILED DESCRIPTION OF THE PREFERRED EMBODIMENTS

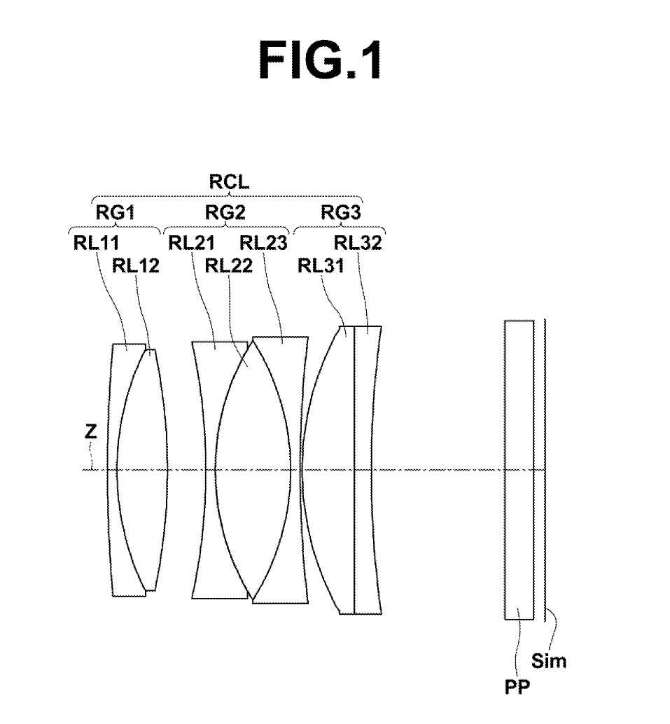

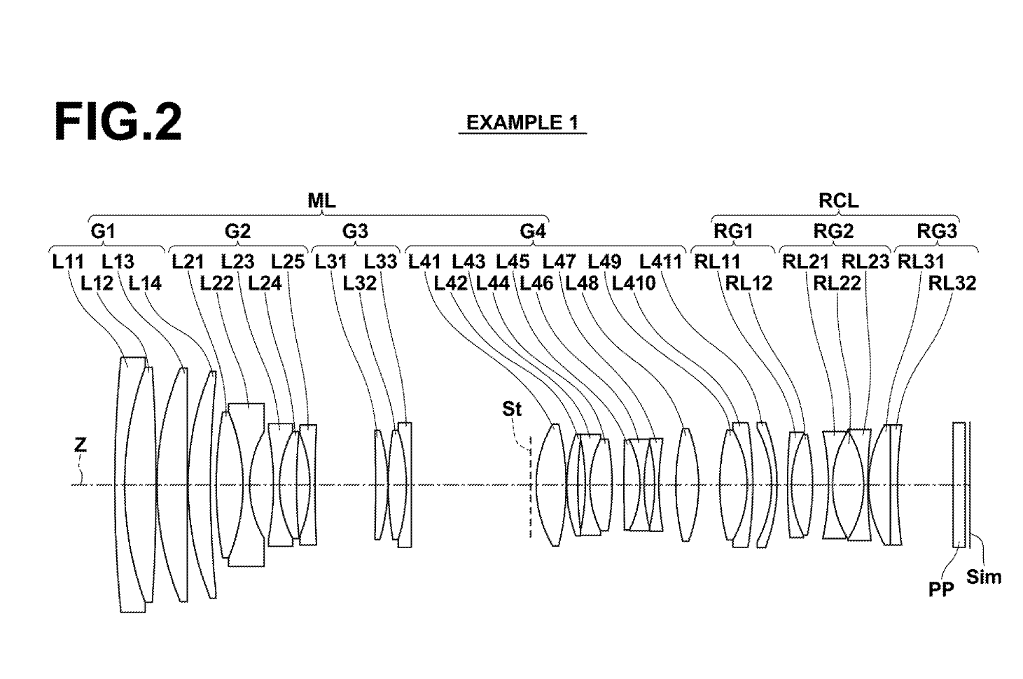

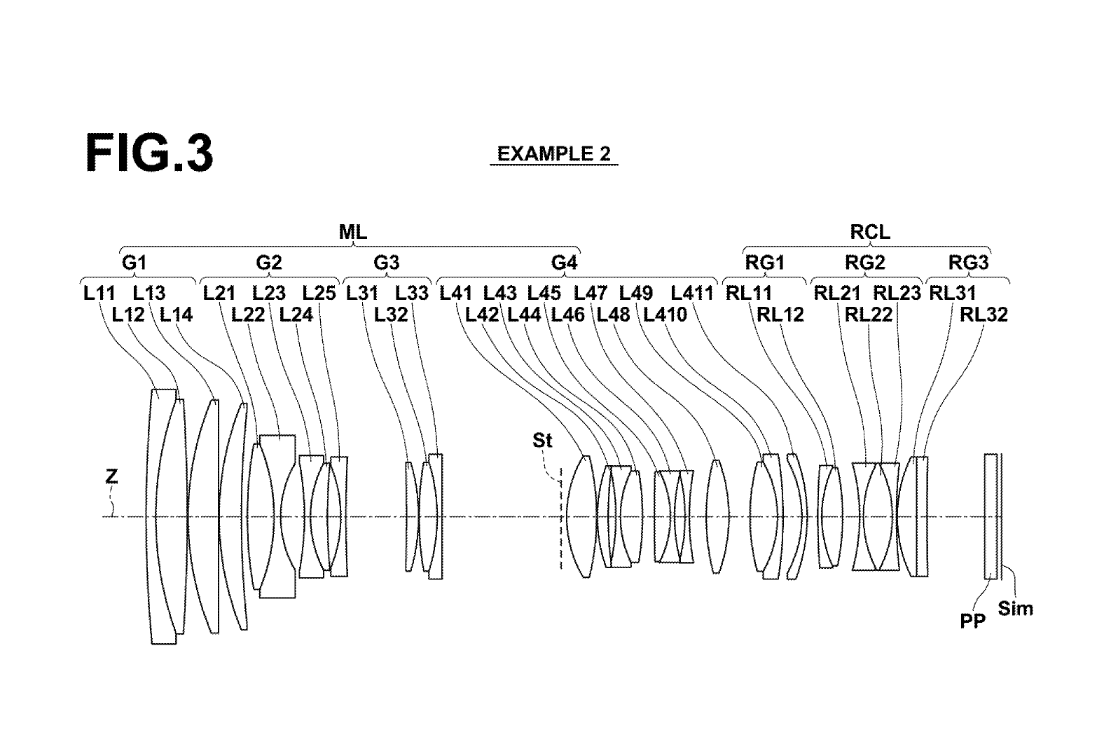

Hereinafter, an embodiment of the present disclosure will be described in detail with reference to drawings. FIG. 1 is a cross section illustrating the lens configuration of rear converter lens RCL according to an embodiment of the present disclosure. FIG. 2 is a cross section illustrating whole configuration in a state in which rear converter lens RCL illustrated in FIG. 1 has been attached to master lens ML. In a similar manner to FIG. 2, FIG. 3 through FIG. 5 are cross sections illustrating whole configuration in a state in which rear converter lenses RCL of configuration examples 2 through 4 have been attached to master lenses ML, respectively. In FIG. 2 through FIG. 5, the basic configuration of each of the configuration examples is the same. Therefore, the configuration example illustrated in FIG. 1 and FIG. 2 will be basically described, and the configuration examples illustrated in FIG. 3 through FIG. 5 will also be described if necessary. In FIGS. 1 through 5, the left side is the object side, and the right is the image side.

Rear converter lens RCL is detachably attached to the image side of master lens ML. Further, rear converter lens RCL has negative focal length, which makes the focal length of the entire system longer than the focal length of the master lens alone by being attached to the image side of master lens ML. Hereafter, a combined optical system (entire system) in which rear converter lens RCL has been attached to master lens ML will be simply referred to as a combined optical system in some cases.

As illustrated in FIG. 1 and FIG. 2, this rear converter lens RCL consists of, in order from the object side, first lens group RG1 having positive refractive power, second lens group RG2 having negative refractive power and third lens group RG3 having positive refractive power along optical axis Z. It is possible to suppress a change in a spherical aberration and a change in curvature of field caused by attachment of rear converter lens RCL by arranging, in order from the object side, positive refractive power, negative refractive power and positive refractive power of first lens group RG1, second lens group RG2 and third lens group RG3. Hereafter, first lens group RG1 included in rear converter lens RCL, second lens group RG2 included in rear converter lens RCL and third lens group RG3 included in rear converter lens RCL will be simply referred to as first lens group RG1, second lens group RG2 and third lens group RG3, respectively.

Further, it is possible to make the position of a front principal point of the combined optical system further toward the image side, because first lens group RG1 has positive refractive power. Therefore, it is possible to suppress an increase in the back focus of the combined optical system. Hence, rear converter lens RCL is appropriately usable as an interchangeable lens of a non-reflex digital camera.

Further, first lens group RG1 consists of a cemented lens of negative lens RL11 (a first lens in the first lens group) having a concave surface facing the image side and positive lens RL12 (a second lens in the first lens group) cemented together in order from the object side. Therefore, it is possible to suppress a change in a longitudinal chromatic aberration caused by attachment of rear converter lens RCL. Further, it is possible to suppress generation of ghost between lenses in first lens group RG1 by making first lens group RG1 consist of a cemented lens. Further, it is possible to reduce an influence of a relative positional error between lenses, such as eccentricity.

Second lens group G2 consists of a cemented lens of negative lens RL21 (a first lens in the second lens group), positive lens RL22 (a second lens in the second lens group) having a biconvex shape, and negative lens RL23 (a third lens group in the second lens group) cemented together in order from the object side. In second lens group RG2 having negative refractive power, if the negative refractive power is increased to secure sufficient negative refractive power, a change in a longitudinal chromatic aberration caused by attachment of rear converter lens RCL tends to increase. However, it is possible to minimize generation of the longitudinal chromatic aberration caused by attachment of rear converter lens RCL by making second lens group RG2 consist of a cemented lens of negative lens RL21, positive lens RL22, and negative lens RL23 cemented together in order from the object side. Further, it is possible to suppress generation of ghost between lenses by making second lens group RG2 consist of a cemented lens. Further, it is possible to reduce an influence of a relative positional error between lenses, such as eccentricity.

Third lens group RG3 has positive refractive power. It is possible to suppress a change in a spherical aberration and a change in curvature of field caused by attachment of rear converter lens RCL by making third lens group RG3, which is arranged furthest toward the image side, have positive refractive power. Further, third lens group RG3 includes lens RL31 (a first lens in the third lens group) having a convex surface facing the object side furthest toward the object side. As a result, it is possible to more appropriately suppress a change in a spherical aberration caused by attachment of rear converter lens RCL.

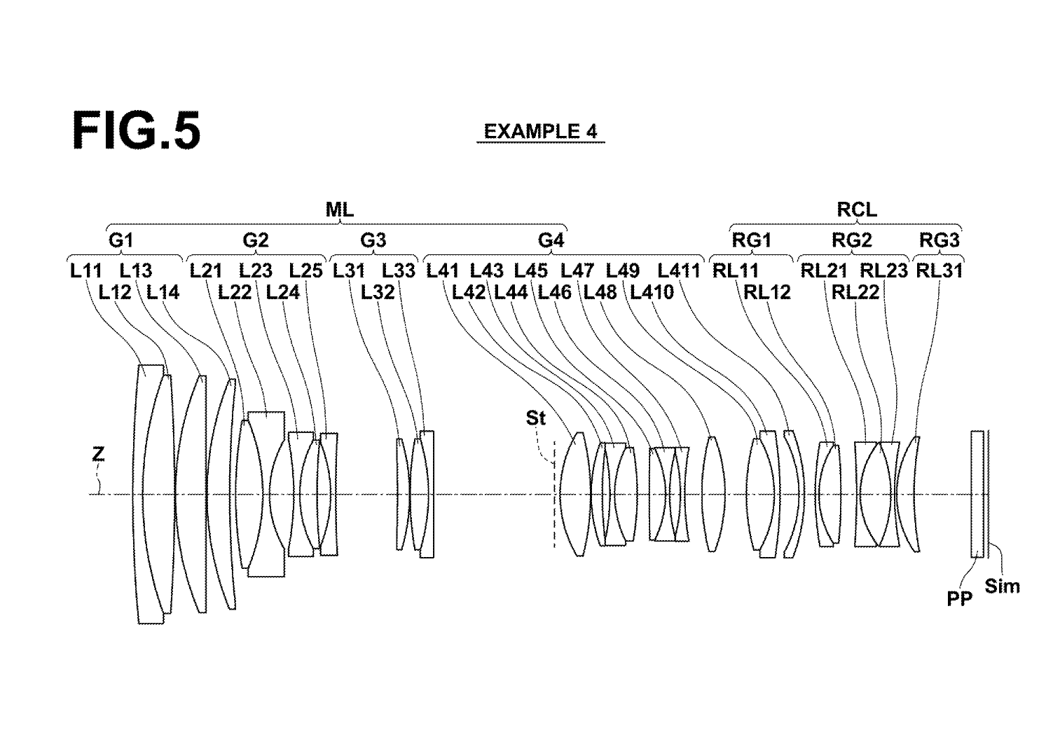

Further, it is desirable that third lens group RG3 consists of a lens or a cemented lens. In such a case, it is possible to more appropriately suppress a change in a spherical aberration and a change in curvature of field caused by attachment of rear converter lens RCL. Further, it is possible to suppress the problem of generation of ghost between lenses and an influence of a relative positional error between lenses by making third lens group RG3 consist of a lens or a cemented lens. FIG. 2 through 4 illustrate configuration examples in which third lens group RG3 consists of a cemented lens of positive lens RL31 (a first lens in the third lens group) having a convex surface facing the object side and negative lens RL32 (a second lens in the third lens group) cemented together. In the case that third lens group RG3 consists of a cemented lens, it is possible to appropriately suppress a change in curvature of field and a change in a lateral chromatic aberration caused by attachment of rear converter lens RCL. FIG. 5 illustrates a configuration example in which third lens group RG3 consists of positive lens RL31 (the first lens in the third lens group) having a meniscus shape with its convex surface facing the object side. In the case that third lens group RG3 consists of a single lens, the configuration is advantageous to reduction in the weight of rear converter lens RCL.

In the three group configuration consisting of, in order from the object side, first lens group RG1 having positive refractive power, second lens group RG2 having negative refractive power and third lens group RG3 having positive refractive power, rear converter lens RCL optimizes the structure of each lens element in first lens group RG1 through third lens group RG3. Therefore, it is possible to achieve rear converter lens RCL having high optical performance, in which various aberrations, such as a spherical aberration and chromatic aberrations, are excellently suppressed.

In the example illustrated in FIG. 2, master lens ML is a zoom lens consisting of, in order from the object side, first lens group G1, second lens group G2, third lens group G3, stop St and fourth lens group G4. In FIGS. 2 through 5, master lens ML is the same. Meanwhile, stop St (aperture stop) in master lens ML does not necessarily represent the size nor the shape of stop St, but the position of stop St on optical axis Z. In master lens ML, first lens group G1 and fourth lens group G4 are fixed during magnification change from a wide-angle end to a telephoto end, and each of second lens group G2 and third lens group G3 moves toward the image side during magnification change from the wide-angle end to the telephoto end.

Further, first lens group G1 in master lens ML consists of four lenses of lens L11 through L14. Second lens group G2 in master lens ML consists of five lenses of lens L21 through L25. Third lens group G3 in master lens ML consists of three lenses of lens L31 through L33. Fourth lens group G4 in master lens ML consists of 11 lenses of lens L41 through L411.

Next, action and effect about conditional expressions of rear converter lens RCL, configured as described above, will be described more in detail. It is desirable that rear converter lens RCL satisfies one of the following conditional expressions or an arbitrary combination thereof. It is desirable that a conditional expression or expressions to be satisfied are appropriately selected based on what is needed for rear converter lens RCL.

First, rear converter lens RCL satisfies the following conditional expression (1) when the focal length of third lens group RG3 is f3, and the focal length of rear converter lens RCL is cf:

−1.9<f3/cf<−0.4 (1).

The position of a front principal point of rear converter lens RCL does not become too close to the image side by suppressing the focal length of third lens group RG3 so as to satisfy the lower limit of conditional expression (1), and it is possible to prevent the position of an object point of rear converter lens RCL from becoming too close to the image side. Therefore, it is possible to prevent an increase in total lens length by suppressing an increase in the back focus of the combined optical system. Here, a method for increasing a distance on an optical axis between master lens ML and rear converter lens RCL may be considered to prevent an increase in the back focus of the combined optical system. However, in this method, a magnification in a state in which rear converter lens RCL has been attached is low. Further, the position of the front principal point of rear converter lens RCL does not become too close to the object side by securing the focal length of third lens group RG3 so as to satisfy the upper limit of conditional expression (1), and it is possible to prevent the position of the object point of rear converter lens RCL from becoming too close to the object side. Therefore, it is possible to secure the back focus of the combined optical system in a range in which rear converter lens RCL is attachable between the camera body and master lens ML. It is more desirable that conditional expression (1-1) is satisfied to further improve these effects:

−1.7<f3/cf<−0.5 (1-1).

Further, it is desirable that rear converter lens RCL satisfies the following conditional expression (2) when the Abbe number of negative lens RL11 included in first lens group RG1 for d-line is νd1, and the Abbe number of positive lens RL12 included in first lens group RG1 for d-line is νd2:

6.5<νd1−νd2<15 (2).

It is possible to suppress an increase in a longitudinal chromatic aberration by setting a difference in Abbe number between negative lens RL11 and positive lens RL12, which constitute first lens group RG1, so as to satisfy the lower limit of conditional expression (2). It is possible to reduce a change in a lateral chromatic aberration by setting a difference in Abbe number between negative lens RL11 and positive lens RL12, which constitute first lens group RG1, so as to satisfy the upper limit of conditional expression (2). Therefore, it is possible to suppress a change in a longitudinal chromatic aberration and a change in a lateral chromatic aberration in a well-balanced manner by satisfying conditional expression (2). It is more desirable that conditional expression (2-1) is satisfied to further improve these effects:

7<νd1−νd2<13 (2-1).

Rear converter lens RCL is able to achieve higher image formation performance by appropriately satisfying the aforementioned desirable conditions.

In the aforementioned embodiments, rear converter lens RCL optimizes the structure of each lens element in first lens group RG1 through third lens group RG3, and satisfies the aforementioned conditional expression (1). As a result, this rear converter lens RC, which has excellent optical performance, is able to achieve an appropriate back focus while suppressing an increase in total lens length. Further, as this result, it is possible to appropriately apply rear converter lens RCL to a non-reflex digital camera, such as a so-called mirrorless camera. For example, in the examples illustrated in FIG. 2 through FIG. 5, the back focus of a combined optical system is 16.11 through 16.65. The back focus in a range in which rear converter lens RCL is attachable between the camera body and master lens ML is achieved while an increase in total lens length is suppressed.

However, for example, in Example 4 of Patent Document 1, Example 14 of Patent Document 2, Example 2 of Patent Document 3 and Example 2 of Patent Document 4, the back focus of a combined optical system of a rear converter lens and a master lens is 35 mm or more, which is too long. Therefore, there is a concern for an increase in total lens length.

In the case that rear converter lens RCL is used in tough conditions, it is desirable that a multilayer coating for protection is applied to the rear converter lens RCL. Further, an antireflection coating for reducing ghost light during use may be applied besides the coating for protection.

Further, in the examples illustrated in FIG. 2 through FIG. 5, an example in which optical member PP is arranged between a lens system and image plane Sim is illustrated. However, the arrangement is not limited to this. Various filters, such as a low-pass filter and a filter that cuts a specific wavelength band, may be arranged between lenses instead of being arranged between the lens system and image plane Sim. Further, for example, a coating having an action similar to the various filters may be applied to a lens surface of one of the lenses.

Next, a configuration example of master lens ML and numerical value examples of rear converter lens RCL of the present disclosure will be described.

First, master lens ML will be described. FIG. 2 is a cross section in a state in which rear converter lens RCL in Example 1 has been attached to master lens ML. Further, TABLE 1 shows specific lens data corresponding to the configuration of master lens ML alone, and TABLE 2 shows specification and data about variable surface distances.

In the lens data shown in TABLE 1, the column of surface number Si shows the surface number of an i-th surface about an optical system in which signs are assigned in such a manner that numbers sequentially increase toward the image side from an object-side surface of an optical element closest to the object side, as the first surface. The column of curvature radius Ri shows the value of the curvature radius (mm) of the i-th surface from the object side. Similarly, the column of surface distance Di shows a distance (mm) on an optical axis between the i-th surface Si from the object side and the (i+1)th surface S(i+1) from the object side. The column of Ndj shows the value of the refractive index of a j-th optical element from the object side for d-line (wavelength is 587.6 nm). The column of νdj shows the value of the Abbe number of a j-th optical element from the object side for d-line. Here, the sign of a curvature radius is positive when the shape of a surface is convex toward the object side, and negative when the shape of a surface is convex toward the image side. TABLE 1 shows data including stop St and optical member PP. In the column of surface number, the term “(St)” is written together with the surface number of a surface corresponding to stop St.

Further, in TABLE 1, the sign of “DD[ ]” is used for a surface distance that changes during magnification change, and the surface number of an object-side surface of this distance is written in “[ ]”. Specifically, in TABLE 1, DD[7], DD[15] and DD[20] are variable surface distances, which change during magnification change, and correspond to a distance between first lens group G1 and second lens group G2, a distance between second lens group G2 and third lens group G3, and a distance between third lens group G3 and stop St, respectively.

TABLE 2 shows the values of a zoom magnification, focal length f of an entire system, back focus Bf of the entire system, F-number FNo. and maximum angle of view 2ω in a state of being focused on an object at infinity. This back focus Bf represents an air equivalent back focus. Further, TABLE 2 shows the values of variable surface distances at a wide-angle end, a middle focal length state (written in short, as “MIDDLE”, in TABLE 2) and a telephoto end, as variable surface distances. In lens data and data about expressions, degree (°) is used as the unit of angle, and mm is used as the unit of length. However, since an optical system is usable by proportionally being enlarged or by proportionally being reduced, other appropriate units may be used.

TABLE 1
MASTER LENS

| Si | Ri | Di | Ndj | νdj |
|---|---|---|---|---|
| 1 | 314.4308 | 2.2900 | 1.80100 | 34.97 |
| 2 | 80.8630 | 7.4000 | 1.49700 | 81.54 |
| 3 | −411.8253 | 0.2000 | | |
| 4 | 70.8095 | 7.1000 | 1.43875 | 94.94 |
| 5 | ∞ | 0.2000 | | |
| 6 | 69.9388 | 5.2400 | 1.49700 | 81.54 |
| 7 | 243.2625 | DD[7] | | |
| 8 | 97.3350 | 6.2800 | 1.72047 | 34.71 |
| 9 | −44.4430 | 1.5400 | 1.62230 | 53.17 |
| 10 | 24.5106 | 5.6000 | | |
| 11 | −67.3261 | 1.4100 | 1.49700 | 81.54 |
| 12 | 26.8210 | 4.0000 | 1.84661 | 23.88 |
| 13 | 128.9145 | 3.1300 | | |
| 14 | −31.5621 | 1.2000 | 1.91082 | 35.25 |
| 15 | 268.8915 | DD[15] | | |
| 16 | −454.7411 | 2.8500 | 1.80100 | 34.97 |
| 17 | −44.3534 | 0.1000 | | |
| 18 | 73.4584 | 4.2600 | 1.61800 | 63.33 |
| 19 | −43.2070 | 1.1700 | 1.80518 | 25.42 |
| 20 | ∞ | DD[20] | | |
| 21(St) | ∞ | 1.3000 | | |
| 22 | 27.8674 | 7.0500 | 1.49700 | 81.54 |
| 23 | −58.7589 | 0.1500 | | |
| 24 | 34.5685 | 2.5700 | 1.65412 | 39.68 |
| 25 | 84.5573 | 1.8000 | | |
| 26 | −50.7158 | 1.1000 | 1.90366 | 31.31 |
| 27 | 23.9830 | 5.2100 | 1.49700 | 81.54 |
| 28 | −62.4364 | 2.8000 | | |
| 29 | 452.2104 | 3.7600 | 1.80518 | 25.42 |
| 30 | −23.3710 | 0.9600 | 1.58913 | 61.13 |
| 31 | 39.4316 | 2.4800 | | |
| 32 | −40.8960 | 1.0000 | 1.80100 | 34.97 |
| 33 | 60.1440 | 3.9700 | | |
| 34 | 53.0700 | 5.3600 | 1.80000 | 29.84 |
| 35 | −37.6531 | 4.9500 | | |
| 36 | 49.5305 | 6.4600 | 1.48749 | 70.24 |
| 37 | −26.0930 | 1.3100 | 1.80518 | 25.42 |
| 38 | −92.8937 | 4.4000 | | |
| 39 | −27.4751 | 1.2600 | 1.91082 | 35.25 |
| 40 | −40.9228 | 26.4281 | | |
| 41 | ∞ | 2.8500 | 1.51680 | 64.20 |
| 42 | ∞ | 1.1000 | | |

TABLE 2
MASTER LENS

| | WIDE-ANGLE | | |
|---|---|---|---|
| | END | MIDDLE | TELEPHOTO END |
| ZOOM | 1.0 | 1.6 | 2.6 |
| MAGNIFICATION | | | |
| f | 51.52 | 83.69 | 135.96 |
| Bf | 29.41 | 29.41 | 29.41 |
| FNo. | 2.88 | 2.89 | 2.88 |
| 2ω | 30.6 | 18.8 | 11.6 |
| DD[7] | 1.39 | 19.54 | 31.16 |
| DD[15] | 14.30 | 9.95 | 2.69 |
| DD[20] | 27.99 | 14.19 | 9.82 |

The meaning of signs in the above tables was described by using TABLE 1, 2, as examples. The meaning is basically the same for TABLE 3 through 10. TABLE 3 through TABLE 10 show each data about whole configuration in which master lens ML shown in TABLE 1, 2 and rear converter lens RCL corresponding to Examples 1 through 4 are combined together. In Examples 1 through 4, the same master lens ML is illustrated. Lens data about rear converter lens RCL in Examples 1 through 4 are indicated by bold frames in TABLE 3, 5, 7 and 9. Further, in TABLE 2, focal length f of the entire system shows the focal length of master lens ML alone. In TABLE 4, 6, 8 and 10, focal length f of the entire system shows the combined focal length of a combined optical system in which rear converter lens RCL and master lens ML are combined together. In TABLE 2, back focus Bf of the entire system shows the back focus of master lens ML alone. In TABLE 4, 6, 8 and 10, back focus Bf of the entire system shows the back focus of the combined optical system in which rear converter lens RCL and master lens ML are combined together.

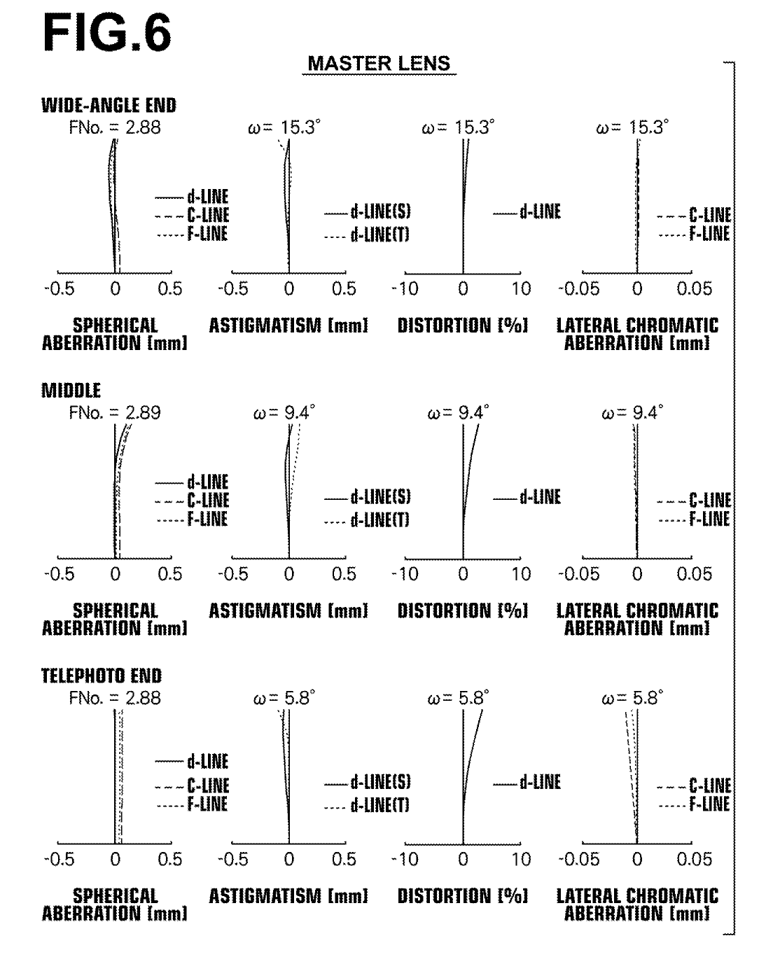

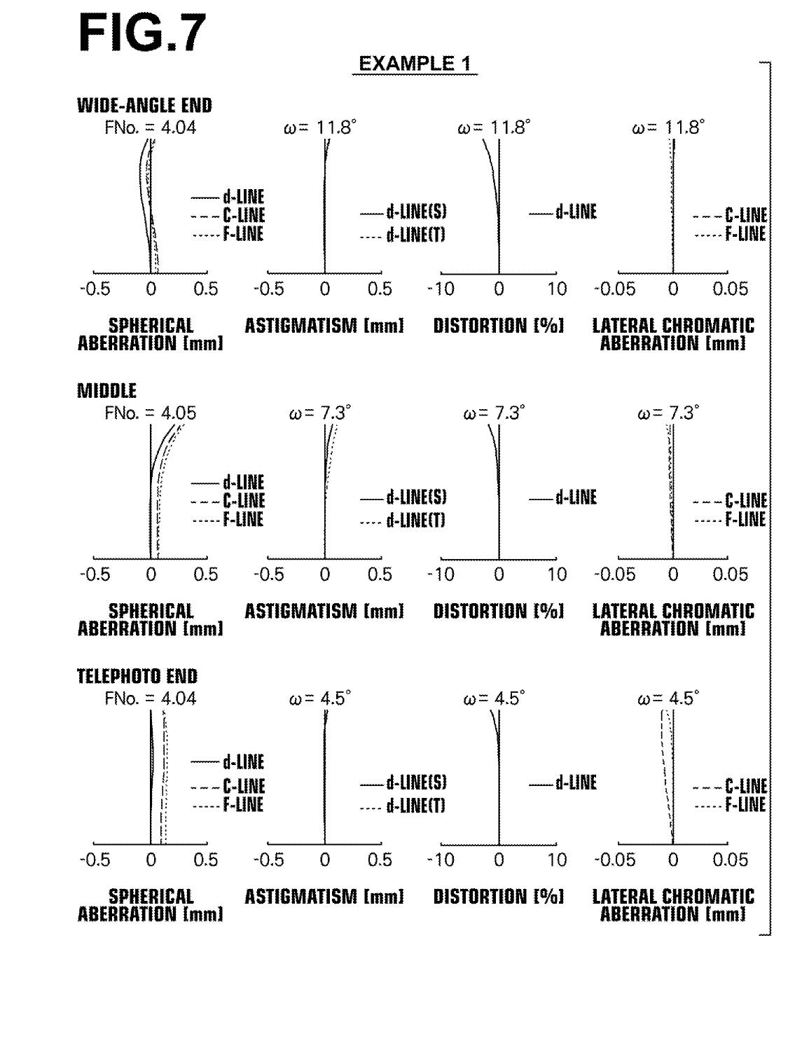

FIG. 6 illustrates aberration diagrams of master lens ML alone. In FIG. 6, aberrations at a wide-angle end are illustrated in the top row, in order from the left side, as a spherical aberration, astigmatism, distortion, and a lateral chromatic aberration. Aberrations at middle are illustrated in the middle row, in order from the left side, as a spherical aberration, astigmatism, distortion, and a lateral chromatic aberration. Aberrations at a telephoto end are illustrated in the bottom row, in order from the left side, as a spherical aberration, astigmatism, distortion, and a lateral chromatic aberration. In FIG. 6, aberration diagrams of a spherical aberration, astigmatism and distortion illustrate aberrations for d-line (wavelength is 587.6 nm). An aberration diagram of a spherical aberration indicates aberrations for d-line, C-line (wavelength is 656.3 nm) and F-line (wavelength is 486.1 nm) with a solid line, a broken line and a dotted line, respectively. An aberration diagram of astigmatism indicates aberrations in a sagittal direction and a tangential direction with a solid line and a dotted line, respectively. An aberration diagram of a lateral chromatic aberration indicates aberrations for C-line and F-line with a broken line and a dotted line, respectively. In the spherical aberration diagram, FNo. means an F-number, and in the other aberration diagrams co means a half angle of view. The meaning of these signs was described by using FIG. 6, as an example. The meaning is basically the same for FIGS. 7 through 10. Further, all the aberration diagrams in FIGS. 6 through 10 illustrate aberrations in the case that an object distance is infinity.

Next, rear converter lens RCL in Example 1 will be described. FIG. 1 is a cross section illustrating the lens configuration of rear converter lens RCL in Example 1. FIG. 2 is a cross section illustrating whole configuration in a state in which rear converter lens RCL in Example 1 has been attached to master lens ML. Further, TABLE 3 shows lens data about a combined optical system in which rear converter lens RCL in Example 1 has been attached to master lens ML. TABLE 4 shows specification and data about variable surface distances. Further, FIG. 7 illustrates aberration diagrams in a state in which rear converter lens RCL in Example 1 has been attached to master lens ML.

TABLE 3
EXAMPLE 1

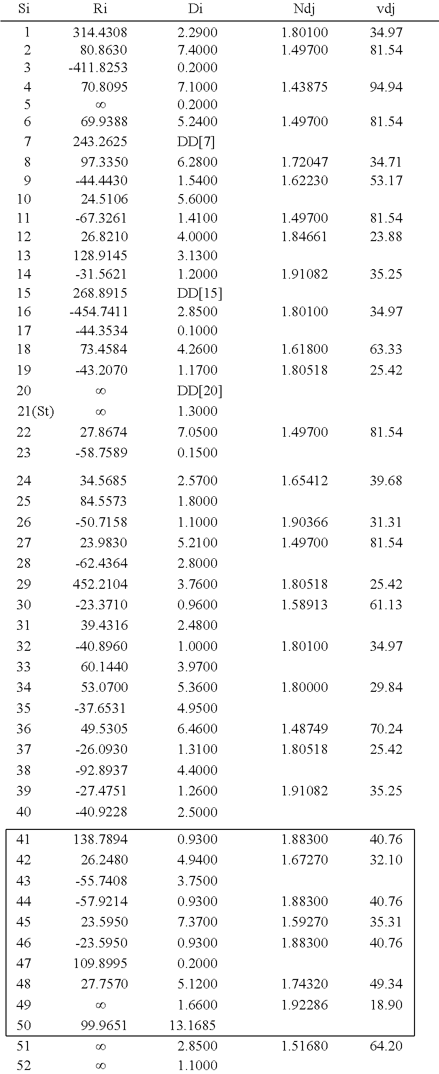

TABLE 4
EXAMPLE 1

| | WIDE-ANGLE | | |
|---|---|---|---|
| | END | MIDDLE | TELEPHOTO END |
| ZOOM | 1.0 | 1.6 | 2.6 |
| MAGNIFICATION | | | |
| f | 72.10 | 117.14 | 190.30 |
| Bf | 16.15 | 16.15 | 16.15 |
| FNo. | 4.04 | 4.05 | 4.04 |
| 2ω | 23.6 | 14.6 | 9.0 |
| DD[7] | 1.39 | 19.54 | 31.16 |
| DD[15] | 14.30 | 9.95 | 2.69 |
| DD[20] | 27.99 | 14.19 | 9.82 |

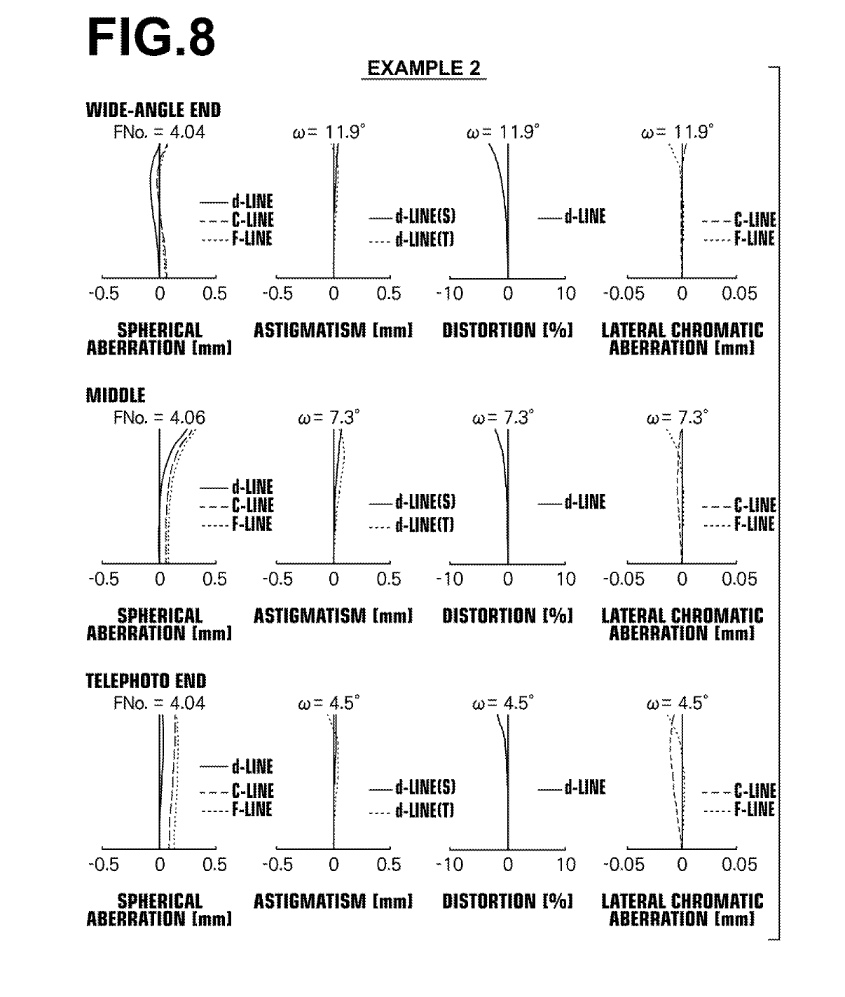

Next, rear converter lens RCL in Example 2 will be described. FIG. 3 is a cross section illustrating whole configuration in a state in which rear converter lens RCL in Example 2 has been attached to master lens ML. Further, TABLE 5 shows lens data about a combined optical system in which rear converter lens RCL in Example 2 has been attached to master lens ML. TABLE 6 shows specification and data about variable surface distances. Further, FIG. 8 illustrates aberration diagrams in a state in which rear converter lens RCL in Example 2 has been attached to master lens ML.

TABLE 5
EXAMPLE 2

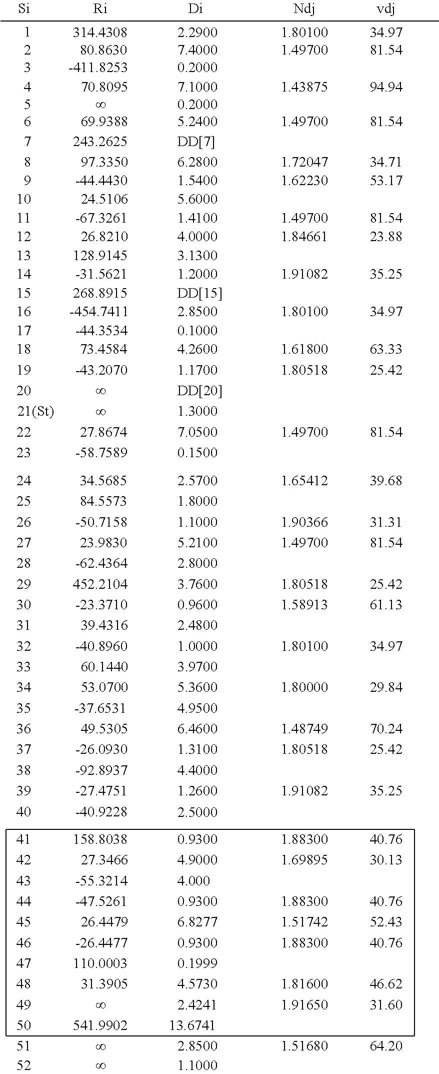

TABLE 6
EXAMPLE 2

| | WIDE-ANGLE | | |
|---|---|---|---|
| | END | MIDDLE | TELEPHOTO END |
| ZOOM | 1.0 | 1.6 | 2.6 |
| MAGNIFICATION | | | |
| f | 72.10 | 117.13 | 190.29 |
| Bf | 16.65 | 16.65 | 16.65 |
| FNo. | 4.04 | 4.06 | 4.04 |
| 2ω | 23.8 | 14.6 | 9.0 |
| DD[7] | 1.39 | 19.54 | 31.16 |
| DD[15] | 14.30 | 9.95 | 2.69 |
| DD[20] | 27.99 | 14.19 | 9.82 |

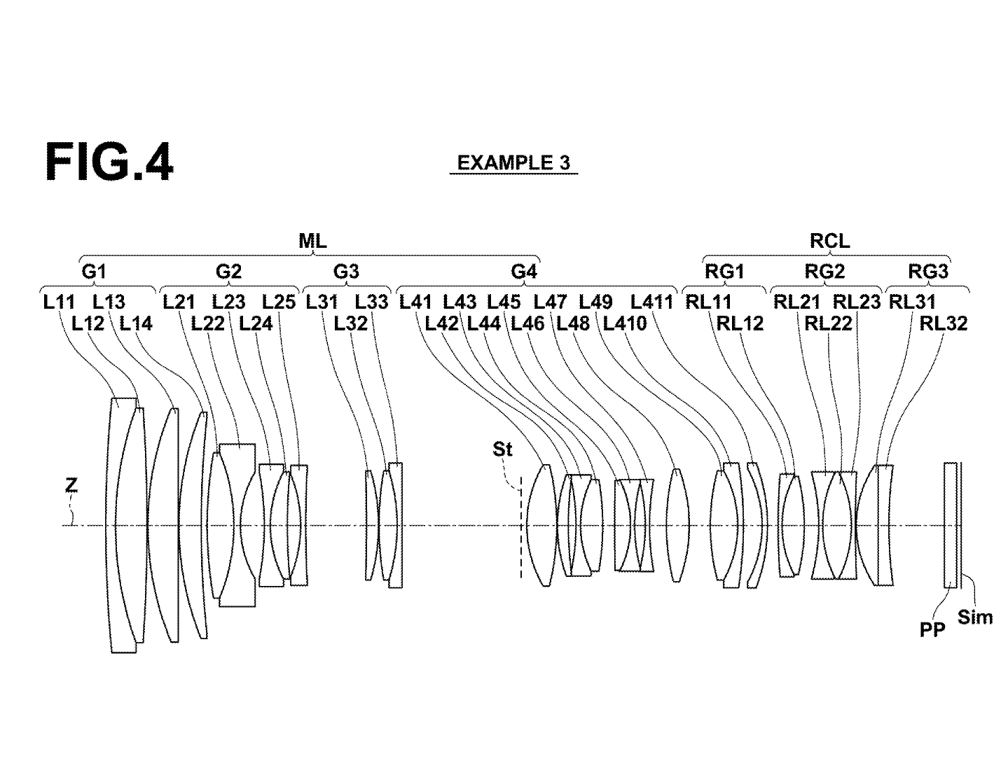

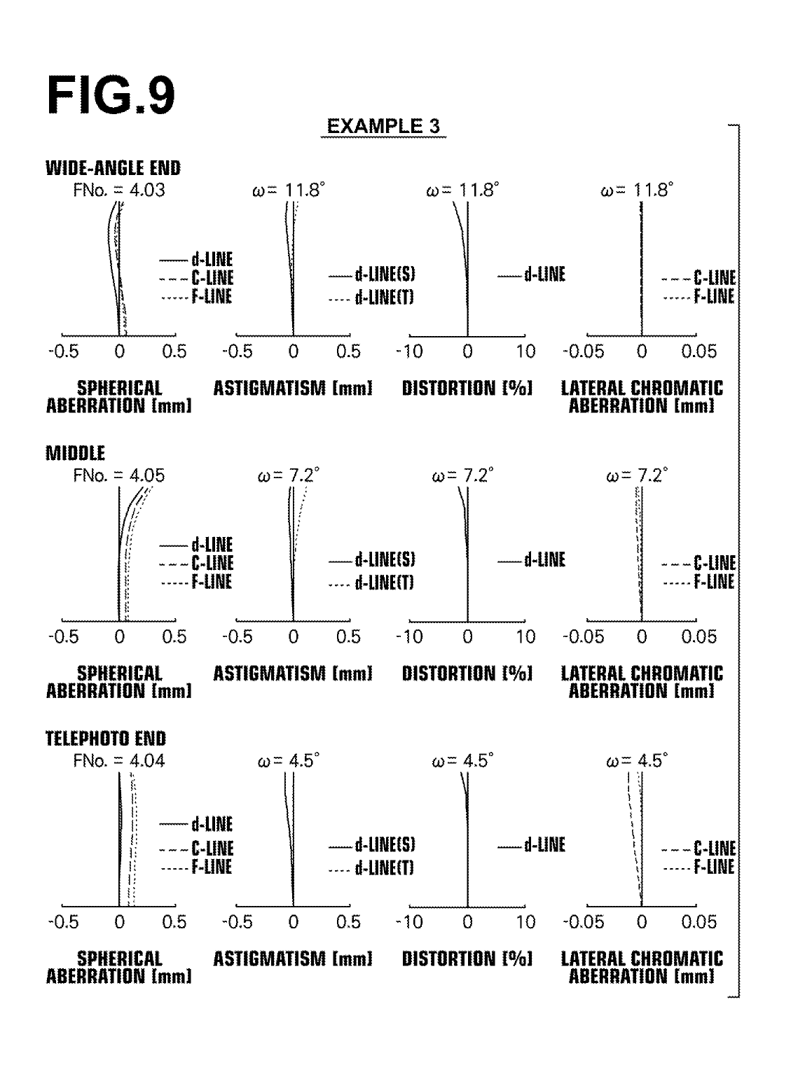

Next, rear converter lens RCL in Example 3 will be described. FIG. 4 is a cross section illustrating whole configuration in a state in which rear converter lens RCL in Example 3 has been attached to master lens ML. Further, TABLE 7 shows lens data about a combined optical system in which rear converter lens RCL in Example 3 has been attached to master lens ML. TABLE 8 shows specification and data about variable surface distances. Further, FIG. 9 illustrates aberration diagrams in a state in which rear converter lens RCL in Example 3 has been attached to master lens ML.

TABLE 7
EXAMPLE 3

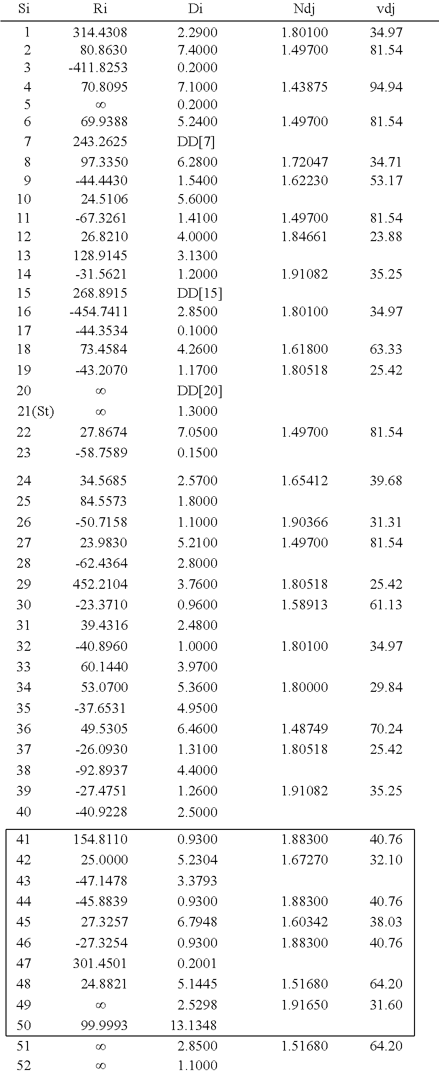

TABLE 8
EXAMPLE 3

| | WIDE-ANGLE | | |
|---|---|---|---|
| | END | MIDDLE | TELEPHOTO END |
| ZOOM | 1.0 | 1.6 | 2.6 |
| MAGNIFICATION | | | |
| f | 72.10 | 117.13 | 190.29 |
| Bf | 16.11 | 16.11 | 16.11 |
| FNo. | 4.03 | 4.05 | 4.04 |
| 2ω | 23.6 | 14.4 | 9.0 |
| DD[7] | 1.39 | 19.54 | 31.16 |
| DD[15] | 14.30 | 9.95 | 2.69 |
| DD[20] | 27.99 | 14.19 | 9.82 |

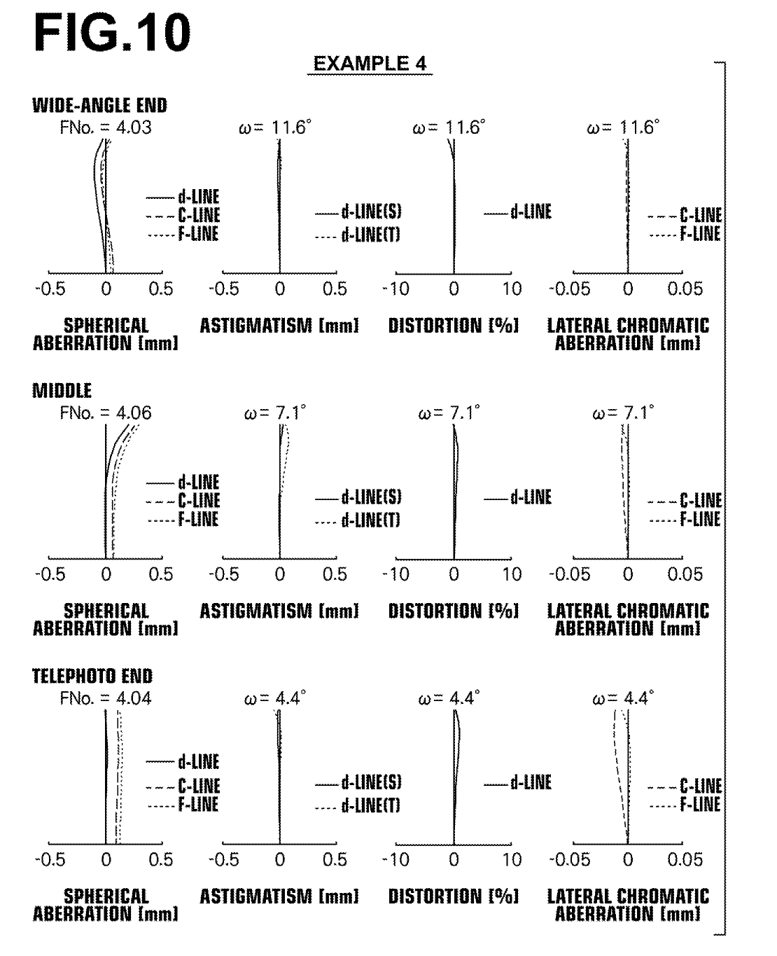

Next, rear converter lens RCL in Example 4 will be described. FIG. 5 is a cross section illustrating whole configuration in a state in which rear converter lens RCL in Example 4 has been attached to master lens ML. Further, TABLE 9 shows lens data about a combined optical system in which rear converter lens RCL in Example 4 has been attached to master lens ML. TABLE 10 shows specification and data about variable surface distances. Further, FIG. 10 illustrates aberration diagrams in a state in which rear converter lens RCL in Example 4 has been attached to master lens ML.

TABLE 9
EXAMPLE 4

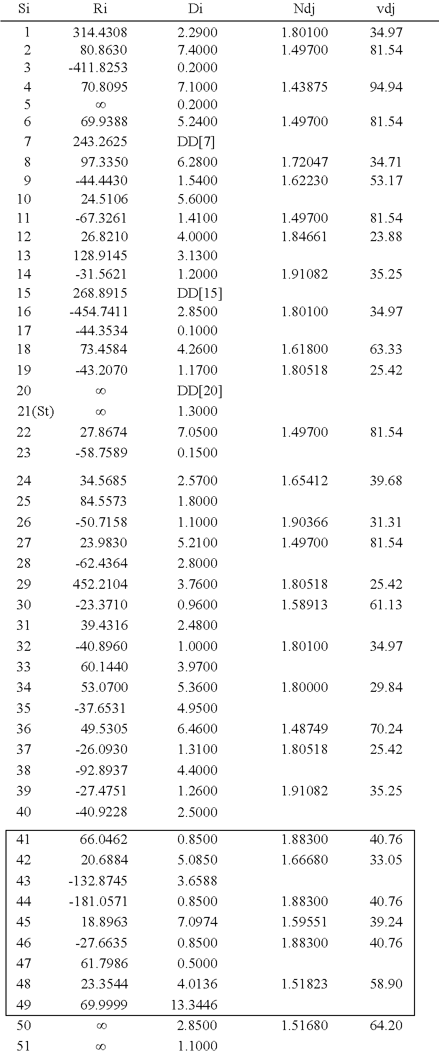

TABLE 10
EXAMPLE 4

| | WIDE-ANGLE | | |
|---|---|---|---|
| | END | MIDDLE | TELEPHOTO END |
| ZOOM | 1.0 | 1.6 | 2.6 |
| MAGNIFICATION | | | |
| f | 72.10 | 117.12 | 190.28 |
| Bf | 16.32 | 16.32 | 16.32 |
| FNo. | 4.04 | 4.06 | 4.04 |
| 2ω | 23.2 | 14.2 | 8.8 |
| DD[7] | 1.39 | 19.54 | 31.16 |
| DD[15] | 14.30 | 9.95 | 2.69 |
| DD[20] | 27.99 | 14.19 | 9.82 |

TABLE 11 shows values corresponding to conditional expressions (1) and (2) of rear converter lens RCL in Examples 1 through 4. In all the examples, d-line is a reference wavelength, and TABLE 11 shows values at this reference wavelength.

TABLE 11

| EXPRESSION | CONDITIONAL | | | | |
|---|---|---|---|---|---|
| NUMBER | EXPRESSION | EXAMPLE 1 | EXAMPLE 2 | EXAMPLE 3 | EXAMPLE 4 |
| 1 | f3/cf | −1.029 | −0.676 | −1.492 | −1.364 |
| 2 | νd1 − νd2 | 8.66 | 10.63 | 8.66 | 7.71 |

These data show that all of rear converter lenses RCL in Examples 1 through 4 have excellent optical performance, and an appropriate back focus has been achieved while an increase in total lens length is suppressed.

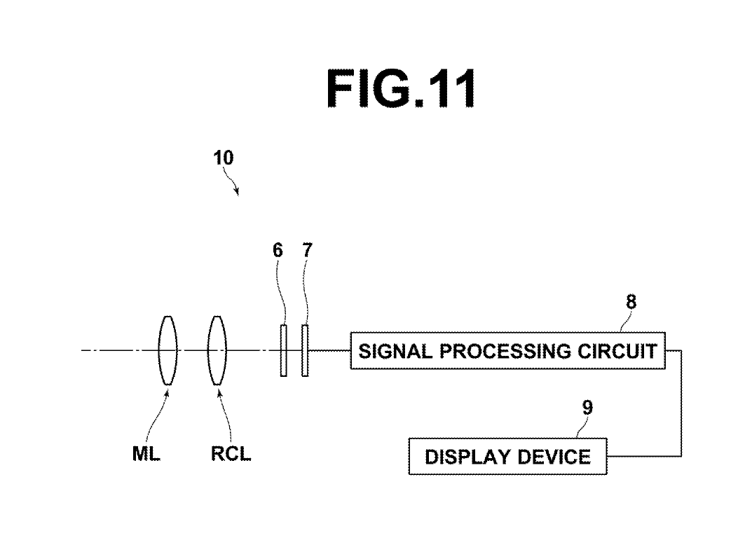

Next, an imaging apparatus 10 according to an embodiment of the present disclosure will be described. FIG. 11 is a schematic diagram illustrating the configuration of the imaging apparatus 10 including rear converter lens RCL according to an embodiment of the present disclosure. The imaging apparatus 10 is a non-reflex digital camera, in which rear converter lens RCL is detachably attached to the image side of master lens ML. In FIG. 11, each lens group is schematically illustrated.

The imaging apparatus 10 illustrated in FIG. 11 includes an imaging lens, which is a combined optical system consisting of rear converter lens RCL and master lens ML, a filter 6 having a function, such as a low-pass filter, and which is arranged toward the image side of the imaging lens, an imaging device 7 arranged toward the image side of the filter 6, and a signal processing circuit 8. Further, the imaging apparatus 10 includes a magnification change control unit (not illustrated) for changing the magnification of master lens ML and a focus control unit (not illustrated) for performing focusing.

Rear converter lens RCL is structured in such a manner to be detachably attached to master lens ML. The imaging device 7 converts an optical image formed by the imaging lens into electrical signals. For example, a CCD (Charge Coupled Device), a CMOS (Complementary Metal Oxide Semiconductor) and the like may be used as the imaging device 7. The imaging device 7 is arranged in such a manner that its imaging surface coincides with the image plane of the imaging lens. An image imaged by the imaging lens is formed on the imaging surface of the imaging device 7. In the signal processing circuit 8, an operation processing is performed on signals about the image output from the imaging device 7, and an image is displayed on a display device 9. An operation for changing magnification is performed by moving second lens group G2 and third lens group G3 of master lens ML (please refer to FIG. 2 through FIG. 5) by the magnification change control unit, which is not illustrated. A focusing operation is performed by the focus control unit, which is not illustrated.

The imaging apparatus 10 according to an embodiment of the present disclosure outputs imaging signals corresponding to an optical image formed by a combined optical system, in which high performance rear converter lens RCL according to an embodiment of the present disclosure and master lens ML are combined together. Therefore, it is possible to obtain high resolution photographic images by appropriately arranging rear converter lens RCL while an increase in the size of the apparatus is suppressed.

So far, the present disclosure has been described by using embodiments and examples. The present disclosure is not limited to the embodiments nor examples, and various modifications are possible. For example, the values of the curvature radius, surface distance, refractive index, Abbe number and the like of each lens element are not limited to the values shown in the numerical value examples, but may be other values.

Further, the embodiment of the imaging apparatus 10 was described by using a rear converter lens attachable to a non-reflex digital camera, for example. However, the imaging apparatus of the present disclosure is not limited to this. For example, the rear converter lens of the present disclosure may be applicable to an imaging apparatus, such as a video camera, a single-lens reflex camera, a film camera, a camera for film making and a camera for broadcasting.

What is claimed is:

1. A rear converter lens having a negative focal length, and which makes a focal length of an entire system longer than a focal length of a master lens alone by being attached to an image side of the master lens, the rear converter lens consisting of three lens groups of, in order from an object side of the rear converter lens:
a first lens group having positive refractive power;
a second lens group having negative refractive power; and
a third lens group having positive refractive power,
wherein the first lens group consists of a cemented lens of a negative lens having a concave surface facing an image side of the rear converter lens and a positive lens cemented together in order from the object side, and
wherein the second lens group consists of a cemented lens of a negative lens, a positive lens having a biconvex shape, and a negative lens cemented together in order from the object side, and
wherein the third lens group includes a lens having a convex surface facing the object side furthest toward the object side, and
wherein the following conditional expression (1) is satisfied:
−1.9<f3/cf<−0.4 (1), where
f3: a focal length of the third lens group, and
cf a focal length of the rear converter lens.

2. The rear converter lens, as defined in claim 1, wherein the following conditional expression (2) is further satisfied:
6.5<νd1−νd2<15 (2), where
νd1: an Abbe number of the negative lens included in the first lens group for d-line, and
νd2: an Abbe number of the positive lens included in the first lens group for d-line.

3. The rear converter lens, as defined in claim 1, wherein the following conditional expression (1-1) is further satisfied:
−1.7<f3/cf<−0.5 (1-1).

4. The rear converter lens, as defined in claim 1, wherein the following conditional expression (2-1) is further satisfied:
7<νd1−νd2<13 (2-1), where
νd1: an Abbe number of the negative lens included in the first lens group for d-line, and
νd2: an Abbe number of the positive lens included in the first lens group for d-line.

5. The rear converter lens, as defined in claim 1, wherein the third lens group consists of a lens or a cemented lens.

6. An imaging apparatus comprising:
the rear converter lens, as defined in claim 1.
